(19) United States
(12) Patent Application Publication
(10) Pub. No.: US 2004/0065201 A1
(43) Pub. Date: Apr. 8, 2004

(54) Electrostatic dust separator with integrated filter tubing

(76) Inventor: Walter Eckert, Schwerzenbach (CH)

Correspondence Address: BACHMAN & LAPOINTE, P.C., 900 CHAPEL STREET, SUITE 1201, NEW HAVEN, CT, 06510, US

(21) Appl. No.: 10/468,374

(22) PCT Filed: Feb. 12, 2002
(86) PCT No.: PCT/CH02/00081

(51) Int. Cl. B03C 3/01

(52) U.S. Cl. 96/55

(57) ABSTRACT

The electrostatic dust separator (10) has integrated filter tubing (12) whereby it is also known as a hybrid filter. The invention comprises plate-type collecting electrodes (14) which are arranged in a substantially parallel manner, filter tubing (12) extending in the channels thus formed (72) parallel to the collecting electrodes, and emission electrodes (16) disposed between the collecting electrodes (14) and the filter tubing (12). The electrodes (14,16) are connected to systems producing high voltage. A filter leading to the electrodes (14,16), a gas outlet (30) and a dust collector funnel (32). The collecting electrodes (14) are electrically insulated in relation to the filter housing (18) and connected to the positive pole of the system for producing high voltage. The negative pole of the system for producing high voltage is connected to the filter housing (24) which forms an earth (24). The emission electrodes (16) with the corona points, and the filter tubing (12) placed in the immediate vicinity thereof, are connected to the filter housing (18) in an electrically conducting manner.

The invention relates to an electrostatic dust separator with integrated filter tubes, comprising plate-like collecting electrodes arranged substantially in parallel, filter tubes extending parallel to the collecting electrodes in the channels formed in this way, and emission electrodes arranged between these collecting electrodes and filter tubes, wherein the electrodes are connected to high-voltage generating plants, and a filter housing has a gas inlet aperture leading to the electrodes, a gas outlet nozzle communicating with the interior of the filter tubes and a dust collecting funnel.

In an electrostatic dust separator of conventional construction, often called an electric filter in brief, the dust-loaded gas to be cleaned is guided through the many parallel channels of a filter housing. The collecting electrodes, which are arranged one behind the other, may have linear dimensions up to about 15 m and more. Arranged longitudinally centrally between the collecting electrodes are the emission electrodes which emit electrons.

While the collecting electrodes of known dust separators are connected to earth, or are earthed, the emission electrodes are connected to high negative direct voltage, which is generally in the range of 30 to 100 kV, but may also exceed this value. An electric field of force is produced between the two electrodes. The electric force concentration on the emission electrode must be large enough to produce a glow or corona discharge which can be seen as a strong, bluish illumination. The discharging electrons ionise the air and other gases forming the atmosphere. The negative and positive ions produced during ionisation migrate to the electrodes of opposite polarity. The migrating ions in turn meet the dust particles suspended in the gas stream, adhere to them and thereby confer an electric charge. Due to the effect of the electrical field the charged dust particles are also attracted by the electrodes of the opposite polarity. The vast majority of the dust particles are negatively charged owing to the emission electrodes emitting the electrons. They deposit on the positive collecting electrodes. Only one to three percent of the dust particles are positively charged and deposit on the emission electrodes with negative potential.

However, the dust particles do not all immediately pass their charge to the relevant electrode, but also, as a result of adhesion and cohesion forces, form loosely connected layers of solid material, in particular on the collecting electrodes.

When the dust layer has reached a thickness of 0.5 to 2 cm, it has to be released from the electrode. This periodic cleaning takes place by means of knocking and shaking devices in dry filters, and in wet filters by means of washing devices. In practice, for example, knocking takes place one to eight times per hour, in that a shaft with tumble hammers is rotated.

The quantity of gas flowing through, the physical constitution of the carrier gas, the moistness and temperature thereof, the electrical resistance and the behaviour of the dust in the electrical field are of essential importance for the efficiency of electric filters. Ultimately, the chemical and particle composition of the dust, the characteristic of the active electric field, the speed of the gas, the whirling up of the dust during knocking, the composition of the gas, the current and the voltage characteristic also determine the speed of migration of the electrically charged particles.

WO A1 90/07382 describes a dust separator containing two functional elements, discharge electrodes and filter tubes. This is an improved filter tube with fibres provided on the tubes which are ionised by the discharge electrodes, the filter tubes having at least one aperture for discharging the gases flowing through the filter material. The filter tubes are also provided with supporting material. The discharge electrodes may be arranged inside and/or outside the filter tubes.

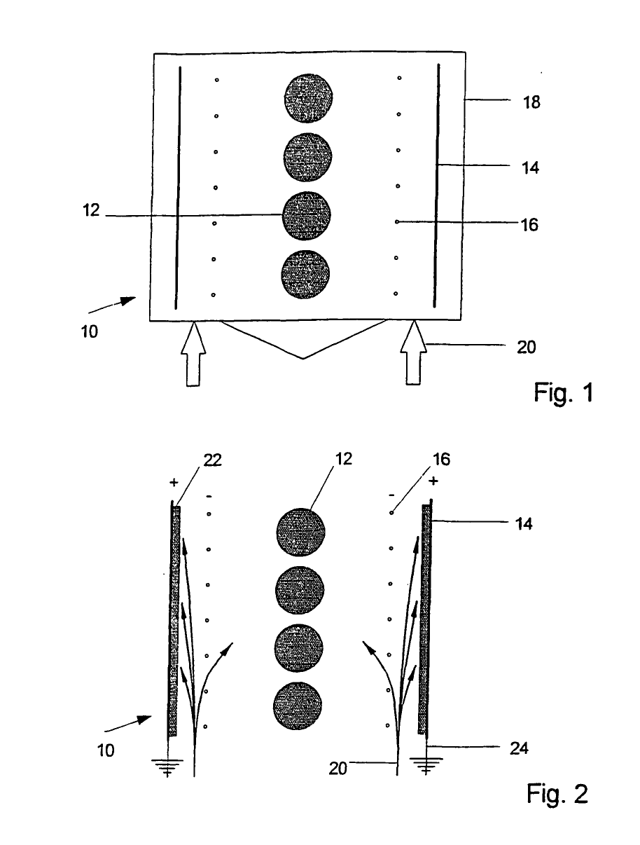

A few years ago hybrid filters, a combination of electric filters with fabric filters, were known. The use of synergies which may be produced between electric and filtering deposition is predominant here. Hybrid filters were previously known in which the electric filters and the fabric filters are spatially separated in the flow direction of the gas. According to WO A1 99/10103, a hybrid filter can be used without the two filter types being spatially separated in the mentioned sense. Basically, every second collecting electrode is replaced by a series of filter tubes which are circular in cross-section. This current prior art is shown in FIGS. 1 and 2.

FIG. 1 shows an electrostatic dust separator 10 with integrated filter tubes 12 which, in an alternating manner, replace a plate-like collecting electrode 14. Arranged adjacent to the two collecting electrodes 14 and parallel to their plane are emission electrodes 16.

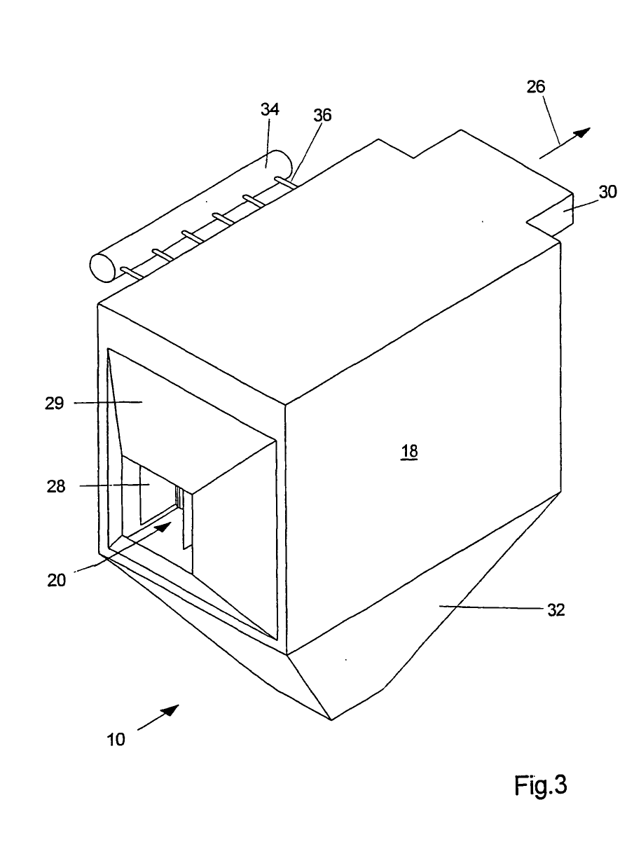

A gas stream 20 charged with dust, the crude gas characterised by arrows, enters the electrostatic dust separator 10 laterally. More than 90% of the dust is deposited on the collecting electrodes 14 owing to the ionisation process described at the outset. Owing to appropriate constructional measures, the crude gas from which the dust has been partially removed is forced to leave the electrostatic dust separator 10 through the filter tubes 12 as clean gas 26 (FIG. 3) with an extraordinarily low dust content.

Some further details from the mentioned WO A1 99/10103 emerge from FIG. 2. The emission electrodes 16 are insulated with respect to the housing 18 of the electrostatic dust separator 10 (FIG. 1) and are connected to the negative pole of a high voltage generating plant, not shown. The positive pole of the high-voltage generating plant is connected to earth 24. The plate-like collecting electrodes 14 and the filter tubes 12 are connected to the filter housing 18. The dust particles of the crude gas stream 20 are substantially deflected in the direction of the collecting electrodes 14 and form a dust layer 22 thereon which is removed by regular knocking. Only a relatively small number of dust particles are deflected in the direction of the filter tubes 12.

The object of the invention is to provide a dust separator of the type mentioned at the outset, which allows an increase in output per unit volume and therefore operates more economically.

The object is achieved according to the invention in that the collecting electrodes are electrically insulated with respect to the filter housing and are connected to the positive pole of the high-voltage generating plant, the negative pole of the high-voltage generating plant is connected to the filter housing forming the earth, and the emission electrodes are connected to the corona points, just as the filter tubes which are provided directly next to them are connected in an electrically conductive manner to the filter housing. Special and developing embodiments of the device are the subject of dependent claims.

Owing to the identical electrical potential of the emission electrodes and the filter tubes, the dead space in which dust can reach the filter tubes without pre-ionisation is dispensed with. The spacing of the emission electrodes from the filter tubes can be kept smaller in this way.

The spacing of the emission electrodes or the corona points from the associated collecting electrode is suitably at least twice as large as the spacing of the emission electrodes from the next filter tube. This spacing of the emission electrode or corona points from the collecting electrode is preferably three to ten time greater than the spacing of the emission electrode from the closest filter tube.

According to a first variation, the mentioned spacing ratios are produced in that the filter tubes arranged in series parallel to the collecting electrode have smaller and larger spacings in an alternating manner, in other words the filter tubes are grouped in pairs. The emission electrodes with corona points can thus be arranged in the gap formed by the greater spacings of the filter tubes, at least in the direction of the associated collecting electrode. The spacing of the emission electrodes in practice located either side of the longitudinal central plane of the filter tubes suitably corresponds to roughly the radius of the filter tubes, but may also be relatively slightly larger or smaller.

According to a different, particularly advantageous variation, the filter tubes have an inner support basket made of mechanically rigid material even at working temperatures, for example made of a mechanically rigid plastics material or an easily processable metal. The inner basket has a purely supporting function, not an electrical function. Metallic inner filter baskets are connected during operational use directly to earth and/or by a metal wire or strip to the relevant discharge electrode.

Arranged outside the filter tube at a spacing is a gas-permeable emission electrode, which is made of a metal material, formed as an outer basket with corona points directed outwardly and is connected to the filter housing forming the earth.

The corona points are regularly distributed over the entire periphery of the basket-like emission electrode or arranged in a concentrated manner in the direction of the associated collecting plates.

The corona points and the filter tube are advantageously at a spacing of 20 to 70 mm, in particular about 30 to 50 mm, from one another.

Normal filter media can be used for the filter tubes. However, antistatic material with a membrane is preferred. The filter tubes are separated completely from the electrical field. The filter tubes, although normally supported by the inner basket, can also be suspended on an inner side of the outer filter basket forming the emission electrode which is especially designed for this purpose.

The filter tubes are normally formed circularly with respect to their cross-section. However, the cross-section can adopt any shape which can be handled in practice, for example square, elliptical, rectangular, oblong or oblong with semi-circularly formed narrow sides. The inner and outer basket are formed so as to be correspondingly adapted.

The outer filter basket formed as an emission electrode and the supported filter tube may be designed as an assembly module. In other words the first fitting may take place in that the outer basket electrode with the corona points can be installed together with the tube and inner basket as a pre-assembled module. When a filter tube is replaced, the entire module is replaced, and the actual replacement of the filter tube takes place in the workshop.

According to a variation, the outer basket with the corona points can be fitted first, then the tube and finally the inner basket, in other words the support basket for the filter tube. When a tube is changed, the outer basket electrode with the corona points is left in the filter plant. When the new filter tube is inserted, the outer basket electrode is a precise guide to the lower stabilising system. The replacement may be made completely from above.

Moreover, the hybrid filters can be operated like previous electric filters. The main quantity of the dust, 95% or more, continues to be deposited on the collecting electrodes which are now electrically insulated with respect to the filter housing. Once the dust layer has reached a predetermined layer thickness, the collecting electrodes are shaken by a knocking mechanism of conventional construction and the dust layer drops down.

The exhaust gas which has been pre-cleaned in this way may leave the filter chamber exclusively through the filter tubes and flow away as clean gas. The filter tubes are also cleaned from time to time, in that compressed air is blown from the inside to the outside through the filter medium. Owing to this cleaning, the dust adhering to the surface of the tube experiences an acceleration in the direction of the electrical field. It is conveyed past the emission electrodes into the electric field and deposited on the collecting electrodes as in a conventional electric filter.

Fabric material is needed for the filter tubes which exploits as well as possible the synergies between an electrical and fabric filter deposition. On the one hand, the fabric filter medium is required to filter the increased fine dust content which is still increasingly contained in the gas stream after the pre-deposition and, on the other hand, to give the adhering dust an optimum possible pulse into the electrical field during cleaning.

To summarise, the present invention has the following substantial advantages:

The spacing of the emission electrodes or corona points from the filter tubes can be substantially smaller than is conventional and therefore the filter housing can also be constructed to be up to 50% smaller.

Owing to the smaller quantity of dust reaching the filter tubes, a higher tube loading as possible.

The dust-like material which is deposited on a filter tube is conveyed during cleaning back into the electrical field and is deposited as in an electric filter. This allows a higher tube loading compared to normal filter tubes.

The identical electrical potential for the emission electrodes and the inner baskets of the filter tubes allows the two to be fixed to one another and to the filter housing at the bottom and with the same system.

The main areas of application for the present invention are the cement industry and combustion plants, such as coal-fired power plants, refuse incineration and heating power stations, etc.

The invention will be described in more detail with the aid of embodiments which are also the subject of dependent claims and are shown in the drawings, which show schematically:

FIG. 3 a perspective view of a hybrid filter,

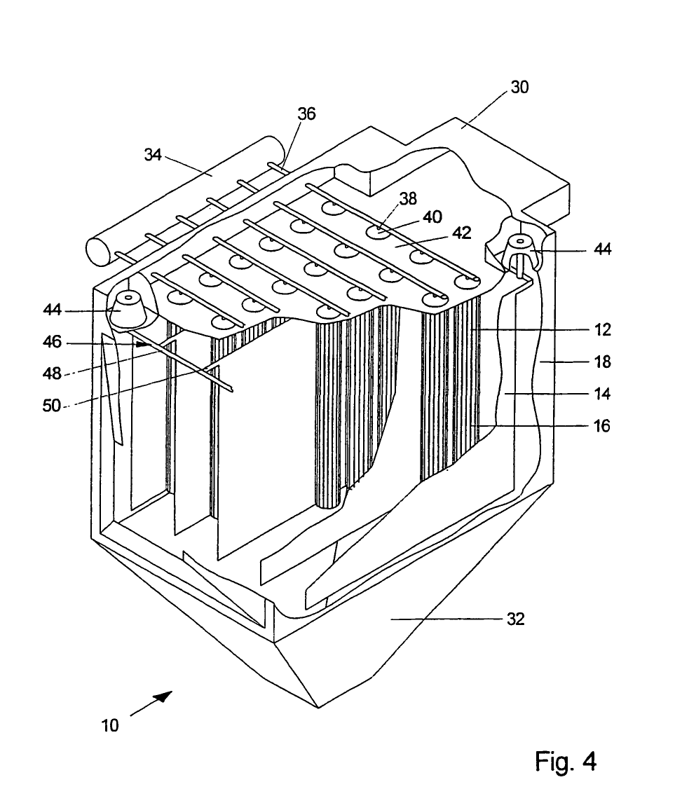

FIG. 4 a partially cut away view according to FIG. 3,

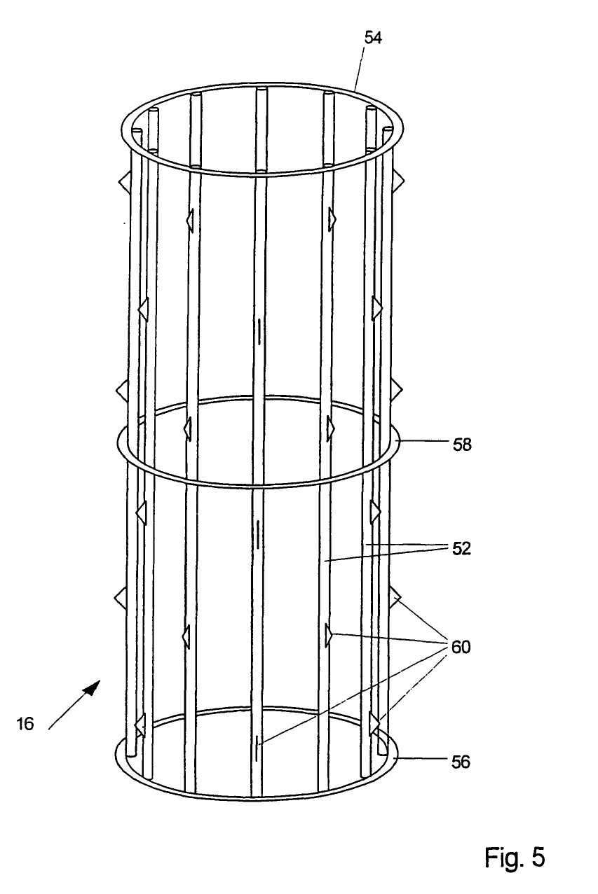

FIG. 5 a perspective view of an emission electrode,

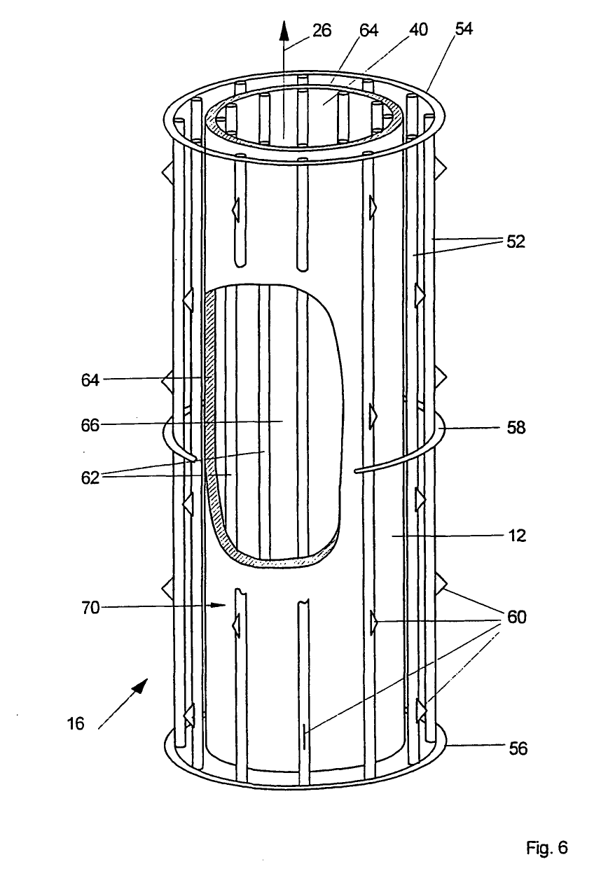

FIG. 6 a partially cut away perspective view of a filter module with an emission electrode and filter tube,

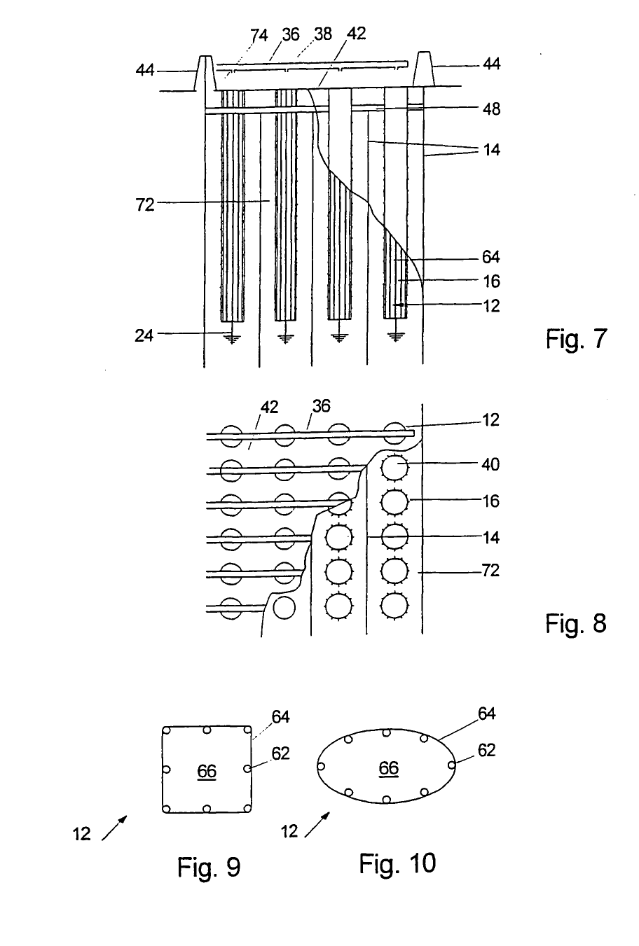

FIG. 7 an elevation of an electrode system,

FIG. 8 a plan view according to FIG. 7,

FIG. 9 a cross-section through a filter tube,

FIG. 10 a variation according to FIG. 9,

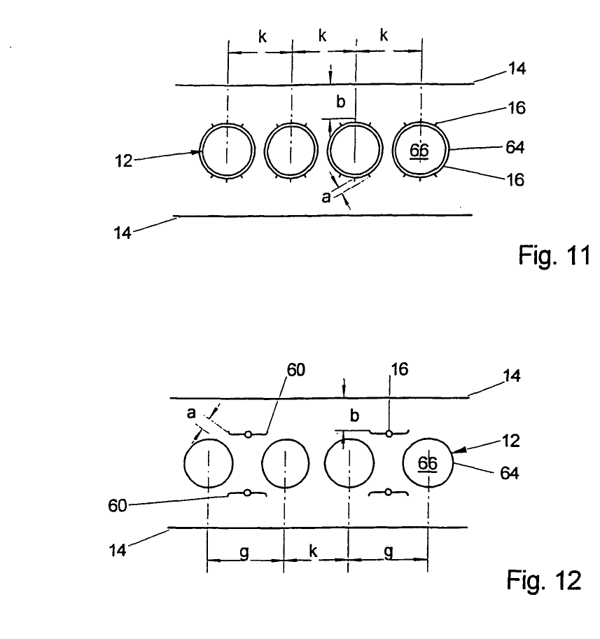

FIG. 11 a plan view of emission electrodes with electrode plates, and

FIG. 12 a variation of FIG. 11.

Substantially only the housing 18 is visible of an electrostatic dust separator 10 with non-visible filter tubes. The charged gas stream 20 enters the filter about halfway up and leaves it as a clean gas stream 26.

A gas inlet aperture 28 has a truncated cone-shaped upper part 29, the clean gas 26 leaves the filter by way of a right parallelepiped gas outlet connector 30. A dust collecting funnel 32 is formed below the substantially cuboid housing 18.

A compressed air pipe 34 from which a plurality of pressure lines 36 branch off is fitted in the upper region of the housing 18. These are used to clean the filter tubes 12 by pulses of compressed air, also called pulse jets. Each pressure line 36 leads to a series of filter tubes. This can be seen more easily in FIG. 4. A compressed air nozzle 38 is formed above each aperture 40 of the filter tubes 12.

The filter tubes 12 are surrounded by a filter basket which is shown in detail later and forms the emission electrode 16. The filter tubes 12 themselves are supported by an inner basket which is also shown in detail later.

The emission electrodes 16 are attached in a perforated plate 42. From a certain size, it is advantageous to also fix the emission electrodes 16 in the lower part and to connect them mechanically and electrically to the housing 18 by a stabilising frame.

To build an electric field, the collecting electrodes 14 are electrically insulated with respect to the housing 18 and connected to the positive terminal of a high voltage generating plant, not shown. For this purpose the collecting electrodes 14 are suspended on suspension insulators 44 by way of a frame 46, to be more precise a frame 46 has to be suspended on two respective suspension insulators 44 before and after the field. The plate support irons 50 rest on the upper transverse carrier 48 of the frame 46, two of which irons are rigidly connected to the transverse carrier 48 and form a mechanical connection to the other frame 46. In the process a stress spacing must be observed from the perforated plate 42, for example 150 mm. The plate-like collecting electrodes 14 are attached in the conventional way with bolts in the support irons 50.

The perforated plate 42 separates the crude gas from the clean gas region. The filter tubes 12 therefore have to be suspended in a gas-tight manner on the apertures 40 so that leakage is impossible.

Similarly, as shown in FIG. 4, the basket-shaped emission electrodes 16 with the filter tubes 12 can also be attached transversely in the filter housing 18. A filter housing 18 may also be formed in such a way that horizontal guiding of the emission electrodes 16 and the filter tubes 12 is possible.

FIG. 5 shows an emission electrode 16 formed as a metal filter basket. Twelve longitudinal wires 52 are connected to an upper and a lower ring 54, 56 on the inside in an electrically conductive manner at a spacing of 2 to 3 cm. A reinforcement ring 58 is provided between these rings, depending in each case on the length of the basket emission electrode 16.

Corona points 60 pointing outwardly are attached to all the longitudinal wires 52 at regular spacings.

FIG. 6 in turn shows an emission electrode 16 formed as a filter basket, but with a filter tube 12 inserted. This partially cut away filter tube is supported by an inner support basket 62 in a cylindrical surface form. Of this support body, only the longitudinal bars are indicated, the corresponding inner rings are omitted or are not visible for the sake of simplicity.

The filter basket and the support basket form an assembly module which can be fastened in a gas-tight manner to the perforated plate 42 (FIG. 4). The pre-cleaned crude gas, as shown by an arrow 70, enters the inner space 66 of the filter tube 12 through the filter medium 64 and is in the process freed of the last fine-particled dust residues. The clean gas stream 26 discharges from the filter tube 12 by way of the upper filter aperture 68. The gas-tight fastening of the filter tube 12 to the perforated plate 42 (FIG. 4) prevents a gas leakage.

The electrode system is shown in FIGS. 7 and 8, supplementing FIG. 4. It clearly emerges from FIG. 7 that the plate-like collecting electrodes 14 are suspended by suspension insulators 44. The collecting electrodes 14 are also insulated with respect to the housing 18 (FIG. 4) in the lower region. The emission electrodes 16 which are formed as a filter basket, on the other hand, at a certain length are not only fastened to the perforated plate 42 and therefore electrically connected to the filter housing 18 forming the earth 24, but also in the lower region, and this is symbolised by 24.

The perforated plate 42 with the filter tubes 12 suspended in a sealed manner separates the inner space of the hybrid filter into a crude gas space 72 and an upper clean gas space 74. The transition from crude gas space 72 into the clean gas space 74 can take place exclusively by way of the filter tubes 12.

FIGS. 9 and 10 show cross-sections through variations of filter tubes 12. The geometrically cross-sectional shape, in FIG. 9 square and in FIG. 10 elliptical, is established by the relevant support basket 62. Like the filter basket forming the emission electrode 16 and the filter medium 64, this is connected to earth 24. The filter medium 64 suitably consists of fabric material which uses the synergies between electrical and fabric filter deposition as well as possible. On the one hand it has to filter the very fine dust content which, for example, is still contained after pre-deposition in a flue gas, and on the other hand, it has to provide the adhering dust with a best possible pulse into the electric field during cleaning. High-quality PTFE membrane filter tubes (polytetrafluorethylene) easily meet this demand as they deposit the dust on the surface.

FIG. 11 shows a variation of emission electrodes 16 with filter tubes 12 arranged at regular spacings k of 200 mm, for example. The corona points 60 of the filter basket are formed only in the direction of the collecting electrodes 14.

FIG. 12 shows an example of how the emission electrodes 16 can be brought closer to the filter tubes 12 without a filter basket being formed around the filter tube. The filter tubes 12 are arranged alternately with a smaller spacing k of 200 mm, for example, and a larger spacing g of 240 mm, for example. Owing to this pairwise arrangement of filter tubes 12, the emission electrodes 16 can be brought into the gap between the filter tubes 12. The corona points 60 of the emission electrodes 16 are only formed in the direction of the collecting electrodes 14.

It is shown in both embodiments according to FIGS. 11 and 12 that the spacing a of a corona point 60 from the next filter tube 12 is substantially smaller than the spacing b of a corona point 60 from the associated collecting electrode 14.

1. Electrostatic dust separator (10) with integrated filter tubes (12), comprising plate-like collecting electrodes (14) arranged substantially in parallel, filter tubes (12) extending parallel to the collecting electrodes (14) in the channels (72) formed in this way, and emission electrodes (16) arranged between these collecting electrodes (14) and filter tubes (12), wherein the electrodes (14, 16) are connected to high-voltage generating plants, and a filter housing (18) has a gas inlet aperture (28) leading to the electrodes (14, 16), a gas outlet connector (30) communicating with the interior (66) of the filter tubes and a dust collecting funnel (32),
characterised in that
the collecting electrodes (14) are electrically insulated with respect to the filter housing (18) and are connected to the positive pole of the high-voltage generating plant, the negative pole of the high-voltage generating plant is connected to the filter housing (18) forming the earth (24), and the emission electrodes (16) are connected to the corona points (60), just as the filter tubes (12) which are provided directly next to them are connected in an electrically conductive manner to the filter housing (18).

2. Dust separator (10) according to claim 1, characterised in that the spacing (b) of the emission electrodes (16) or the corona points (60) from the associated collecting electrode (14) is at least twice, preferably three to ten times greater than, the spacing (a) of the emission electrodes (16) or the corona points (60) from the next filter tube (12).

3. Dust separator (10) according to claim 1 or 2, characterised in that the filter tubes (12) which are arranged in series parallel to the collecting electrode (14) have alternating smaller (k) and larger spacings (g), the emission electrodes (16) with corona points (60), at least in the direction of the associated collecting electrode (14), being arranged in the gap formed by the larger spacings (g).

4. Dust separator (10) according to claim 1 or 2, characterised in that the filter tubes (12), also with an inner support basket (62), are arranged spaced from an emission electrode (16) which is formed as a gas-permeable, metal filter basket with corona points (60) formed at least in the direction of the collecting electrodes (14).

5. Dust separator (10) according to claim 4, characterised in that the spacing between the corona points (60) and the filter tube (12) is 20 to 70 mm, preferably 30 to 50 mm.

6. Dust separator (10) according to claim 4 or 5, characterised in that the inner support basket (62) of the filter tube (12) consists of plastics material or metal and, together with the filter medium (64), is connected to the filter housing (18) forming the earth (24).

7. Dust separator (10) according to any one of claims 4 to 6, characterised in that the outer filter basket forming the emission electrode (16) and the inner support basket (62) are connected to an electric conductor.

8. Dust separator (10) according to any one of claims 1 to 7, characterised in that the filter tube (12) with an inner support basket (62) is formed so as to be round, square, elliptical, oblong, or oblong with semicircular narrow sides and the emission electrode (16) which is formed as the outer filter basket is adapted to the relevant shape.

9. Dust separator (10) according to any one of claims 1 to 8, characterised in that the filter medium (64) consists of anti-static material.

10. Dust separator (10) according to any one of claims 4 to 9, characterised in that the filter basket forming the emission electrode (16) and the filter tube (12) supported on the inside are formed as an assembly module.
